(19) United States
(12) Patent Application Publication
(10) Pub. No.: US 2007/0222745 A1
(43) Pub. Date: Sep. 27, 2007

(54) ELECTROPHORESIS DEVICE, ELECTRONIC APPARATUS, AND METHOD OF DRIVING ELECTROPHORESIS DEVICE

(75) Inventor: Hideyuki KAWAI, Fujimi (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/674,416

(22) Filed: Feb. 13, 2007

(30) Foreign Application Priority Data
Mar. 22, 2006 (JP) 2006-079253

(51) Int. Cl. G09G 3/34

(52) U.S. Cl. 345/107

(57) ABSTRACT

An electrophoresis device is provided which includes: a display area including electrophoresis elements, each of which has a dispersion system, which includes first electrophoresis particles and second electrophoresis particles having different electrical polarities, between a first electrode and a second electrode disposed opposite to each other; and a voltage control unit allowing the first and second electrophoresis particles to migrate to the first and second electrodes, respectively, so as to form an image by applying a voltage to the electrophoresis elements. Here, the first electrode has a first partial electrode and a second partial electrode and the voltage control unit unevenly distributes the electrophoresis particles distributed close to the first electrode onto one of the first and second partial electrodes by applying different voltages to the first partial electrode and the second partial electrode prior to changing display.

### BACKGROUND

1. Technical Field

The present invention relates to an electrophoresis device, an electronic apparatus, and a method of driving the electrophoresis device.

2. Related Art

A known example of an electrophoresis display device is known which has a structure in which an electrophoresis dispersion liquid including a liquid dispersion medium and at least two types of electrophoresis particles is disposed between a pair of electrodes disposed opposite each other. Such an electrophoresis display device is disclosed in JP-A-62-269124.

In the electrophoresis device having the above-mentioned structure, for example, positively charged white particles and negatively charged black particles are dispersed between the electrodes and two types of electrophoresis particles migrate to several electrodes in the direction of an electric field by applying a voltage across the electrodes. By dividing one electrode into a plurality of pixel electrodes and controlling the potentials of the pixel electrodes, the distributions of both types of particles can be adjusted to form an image.

In the electrophoresis device having the above-mentioned structure, the two types of particles need to be allowed to migrate in opposite directions between both electrodes so as to change the image. However, when the particles migrate, a turbulent flow occurs due to the collisions between particles or close passage of the particles in the liquid, thereby decreasing the migration speed of the particles. As a result, a display change response deteriorates.

### SUMMARY

An advantage of some aspects of the invention is to reduce the number of collisions between electrophoresis particles or the occurrence of a turbulent flow at the time of changing display of an electrophoresis device, thereby enhancing the display change response.

According to an aspect of the invention, there is provided an electrophoresis device including: a display area including electrophoresis elements, each of which has a dispersion system, which includes first electrophoresis particles and second electrophoresis particles having different electrical polarities, between a first electrode and a second electrode disposed opposite to each other; and a voltage control unit allowing the first and second electrophoresis particles to migrate to the first and second electrodes, respectively, so as to form an image, by applying a voltage to the electrophoresis elements. Here, the first electrode has a first partial electrode and a second partial electrode and the voltage control unit unevenly distributes the electrophoresis particles distributed close to the first electrode onto one of the first and second partial electrodes by applying different voltages to the first partial electrode and the second partial electrode prior to changing display.

Accordingly, since the electrophoresis particles close to the first electrode can be unevenly distributed onto any partial electrode prior to changing the display of the electrophoresis device, a flow in a constant direction is generated in the liquid of an electrophoresis layer and thus the particles migrate along the flow. Therefore, it is possible to prevent collision between electrophoresis particles or occurrence of a turbulent flow when the display is changed, thereby enhancing display change response.

The voltage control unit may unevenly distribute the electrophoresis particles migrating to the first electrode onto one of the first and second partial electrodes by applying different voltages to the first partial electrode and the second partial electrode when the display is changed.

Accordingly, it is possible to omit the uneven distributing of the electrophoresis particles onto the first or second partial electrode prior to next changing the display.

The first electrode may be an electrode on a surface opposite to an observation surface. Accordingly, the observed image is less affected.

The area of the first partial electrode may be different from the area of the second partial electrode. Accordingly, since the degree of uneven distribution of the electrophoresis particles increases and thus the directivity of a particle flow becomes more remarkable, it is possible to further reduce the number of collisions between particles or the occurrence of a turbulent flow.

The second electrode may have a third partial electrode and a fourth partial electrode and the voltage control unit may unevenly distribute the electrophoresis particles distributed close to the second electrode onto one of the third and fourth partial electrodes by applying different voltages to the third partial electrode and the fourth partial electrode prior to changing the display.

Accordingly, since the electrophoresis particles can be unevenly distributed onto the first and second electrode, a flow in a constant direction is easily generated in the liquid of the electrophoresis layer. Accordingly, it is possible to almost completely prevent the collision between the electrophoresis particles or the occurrence of a turbulent flow, thereby enhancing display change response.

The voltage control unit may unevenly distribute the electrophoresis particles migrating to the second electrode onto one of the third and fourth partial electrodes by applying different voltages to the third partial electrode and the fourth partial electrode when the display is changed.

Accordingly, it is possible to omit the uneven distributing of the electrophoresis particles prior to next changing the display.

The area of the third partial electrode may be different from the area of the fourth partial electrode. Accordingly, since the degree of uneven distribution of the electrophoresis particles increases and thus the directivity of a particle flow becomes more remarkable, it is possible to further reduce the number of collisions between particles or the occurrence of a turbulent flow.

According to another aspect of the invention, there is provided an electronic apparatus including the above-mentioned electrophoresis device. Here, the electronic apparatuses includes all the apparatuses having a display unit using display resulting from an electrophoresis material and examples thereof include a display, a television set, an electronic paper, a watch, a mobile phone, and a personal digital assistant. The electronic apparatus may include things departing from the concept of an “apparatus”, such as things belonging to real estates such as walls mounted with an electrophoresis film and things belonging to mobile objects such as vehicles, air planes, and ships.

According to another aspect of the invention, there is provided a method of driving an electrophoresis device which has a display area including electrophoresis elements, each of which has a dispersion system, which includes at least two types of electrophoresis particles having different electrical polarities, between a first electrode and a second electrode disposed opposite to each other and which allows first and second electrophoresis particles to migrate to the first and second electrodes, respectively, so as to form an image by applying a voltage to the electrophoresis elements, wherein the first electrode has a first partial electrode and a second partial electrode. Here, the method includes: a first process of unevenly distributing the electrophoresis particles distributed close to the first electrode onto one of the first and second partial electrodes by applying different voltages to the first partial electrode and the second partial electrode prior to changing display; and a second process of reversing the polarities of the first electrode and the second electrode so as to allow the first and second electrophoresis particles to migrate to the opposite electrodes, thereby changing the display.

Accordingly, since the electrophoresis particles close to the first electrode can be unevenly distributed onto any partial electrode prior to changing the display of the electrophoresis device, a flow in a constant direction is generated in the liquid of an electrophoresis layer and thus the particles migrate along the flow. Therefore, it is possible to prevent the collision between the electrophoresis particles or the occurrence of a turbulent flow when the display is changed, thereby enhancing display change response.

In the second process, the electrophoresis particles migrating to the first electrode may be unevenly distributed onto one of the first and second partial electrodes, by applying different voltages to the first partial electrode and the second partial electrode.

Accordingly, it is possible to omit the uneven distributing of the electrophoresis particles onto the first or second partial electrode prior to next changing the display.

According to another aspect of the invention, there is provided a method of driving an electrophoresis device which has a display area including electrophoresis elements, each of which has a dispersion system, which includes at least two types of electrophoresis particles having different electrical polarities, between a first electrode and a second electrode disposed opposite to each other and which allows first and second electrophoresis particles to migrate to the first and second electrodes, respectively, so as to form an image by applying a voltage to the electrophoresis elements, wherein the first electrode has a first partial electrode and a second partial electrode and the second electrode has a third partial electrode and a fourth partial electrode. Here, the method includes: a first process of unevenly distributing the electrophoresis particles distributed close to the first electrode onto one of the first and second partial electrodes by applying different voltages to the first partial electrode and the second partial electrode prior to changing display, and unevenly distributing the electrophoresis particles distributed close to the second electrode onto one of the third and fourth partial electrodes by applying different voltages to the third partial electrode and the fourth partial electrode, prior to changing display; and a second process of reversing the polarities of the first electrode and the second electrode so as to allow the first and second electrophoresis particles to migrate to the opposite electrodes, thereby changing the display.

Accordingly, since the electrophoresis particles can be unevenly distributed onto the first and second electrode, a flow in a constant direction is easily generated in the liquid of the electrophoresis layer. Accordingly, it is possible to almost completely prevent the collision between the electrophoresis particles or the occurrence of a turbulent flow, thereby enhancing display change response.

In the second process, the electrophoresis particles migrating to the first electrode may be unevenly distributed onto one of the first and second partial electrodes by applying different voltages to the first partial electrode and the second partial electrode and the electrophoresis particles migrating to the second electrode may be unevenly distributed onto one of the third and fourth partial electrodes by applying different voltages to the third partial electrode and the fourth partial electrode.

Accordingly, it is possible to omit the uneven distributing of the electrophoresis particles prior to next changing the display.

### BRIEF DESCRIPTION OF THE DRAWINGS

The invention will be described with reference to the accompanying drawings, wherein like numbers reference like elements.

FIG. 1 is a diagram illustrating a section of an electrophoresis display device 1 which is an example of an electrophoresis device according to a first embodiment of the invention.

FIG. 2 is a diagram schematically illustrating a circuit structure of the electrophoresis display device.

FIG. 3 is a diagram illustrating a structure of each pixel driving circuit.

FIG. 4 is an enlarged diagram partially illustrating the section of the electrophoresis display device.

FIG. 5 is an enlarged diagram partially illustrating the circuit structure of the electrophoresis display device.

FIGS. 6A to 6C are diagrams illustrating a method of driving the electrophoresis display device according to the first embodiment of the invention.

FIGS. 7A and 7B are diagrams illustrating another example of the method of driving the electrophoresis display device according to the first embodiment of the invention.

FIG. 8 is a cross-sectional view illustrating another example of the electrophoresis display device according to the first embodiment of the invention.

FIGS. 9A to 9C are diagrams illustrating examples of a shape of a sub-pixel electrode according to the first embodiment of the invention.

FIGS. 10A and 10B are diagrams illustrating a method of driving an electrophoresis display device according to a second embodiment of the invention.

FIGS. 11A to 11C are diagrams illustrating a method of driving an electrophoresis display device according to a third embodiment of the invention.

FIGS. 12A to 12C are diagrams illustrating specific examples of an electronic apparatus employing the electrophoresis display device according to the embodiments of the invention.

### DESCRIPTION OF EXEMPLARY EMBODIMENTS

Hereinafter, exemplary embodiments of the invention will be described with reference to the drawings.

### First Embodiment

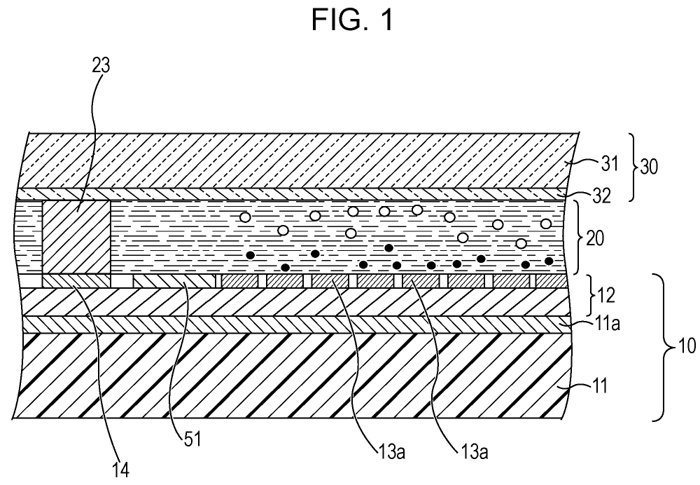

FIG. 1 is a diagram illustrating a section of an electrophoresis display device 1 which is an example of an electrophoresis device according to a first embodiment of the invention. As shown in the figure, the electrophoresis display device 1 roughly includes a first substrate 10, an electrophoresis layer 20, and a second substrate 30. In the figure, the surface close to the second substrate 30 serves as an observation surface and an image is observed through the second substrate 30.

In the first substrate 10, a thin-film semiconductor circuit layer 12 is formed on a flexible substrate 11 as an insulating base for forming an electrical circuit.

The flexible substrate 11 is, for example, a polycarbonate substrate having a thickness of about 200 μm. The thin-film transistor semiconductor circuit layer 12 is formed on (bonded to) the flexible substrate 11 with an adhesive layer 11a formed of, for example, a UV-curable adhesive therebetween. The flexible substrate 11 may be made of a resin material having a small weight and excellent flexibility and elasticity.

The thin-film transistor semiconductor circuit layer 12 includes a group of lines, a group of pixel electrodes, pixel driving circuits, connection terminals, row decoders 51 and column decoders (not shown) for selecting pixels to be driven, which are all arranged in the form of a matrix. Each pixel driving electrode includes a circuit element such as a thin-film transistor (TFT).

The group of pixel electrodes includes a plurality of pixel electrodes (first electrode) 12a arranged in a matrix and forms a display area for an image (two-dimensional information). An active matrix circuit is formed in each pixel electrode 13a so as to apply an individual voltage thereto. The pixel electrodes 13a may not be transparent and may be formed of a metal material such as gold, silver, copper, nickel, or aluminum.

The connection electrodes 14 serve to electrically connect circuit wirings of the first substrate 10 to a transparent electrode layer 32 of the second substrate 30 and are formed in the outer periphery of the thin-film transistor circuit layer 12.

The electrophoresis layer 20 is formed on the pixel electrodes 13a and outer peripheries thereof. The electrophoresis layer 20 includes an electrophoresis dispersion medium and two types of electrophoresis particles having different tones and electrical polarities. The electrophoresis particles have a feature of migrating in the electrophoresis dispersion medium depending on a voltage applied thereto. The thickness of the electrophoresis layer 20 is in the range of 30 μm to 75 μm. For example, water or methanol can be used as the electrophoresis dispersion medium.

As described above, the electrophoresis particles are particles (macromolecules or colloids) having a feature of migrating to a desired electrode due to a potential difference in the electrophoresis dispersion medium. Examples thereof includes a black pigment such as aniline black and carbon black, a white pigment such as titanium dioxide, zinc oxide, antimony trioxide, or aluminum oxide, an azoic pigment such as monoazo, disazo, or polyazo, a yellow pigment such as isoindolinone, chrome yellow, yellow iron oxide, cadmium yellow, titanium yellow, or antimony, a red pigment such as quinacridone red or chrome vermilion, a blue pigment such as phthalocyanine blue, indanthren blue, anthraquinone dye, iron blue, ultramarine blue, or cobalt blue, and a green pigment such as phthalocyanin green.

In the first embodiment, the electrophoresis particles include positively charged white particles (first electrophoresis particles) and negatively charged black particles (second electrophoresis particles).

The second substrate 30 is formed of a thin film (transparent insulating synthetic resin base) 31 in which a transparent electrode layer (second electrode) 32 is formed on the bottom surface thereof so as to cover the electrophoresis layer 20. The thickness of the second substrate 30 is preferably in the range of 10 to 200 μm and more preferably in the range of 25 to 75 μm.

The thin film 31 serves to seal and protect the electrophoresis layer 20.

The transparent electrode layer 32 is formed of an indium tin oxide (ITO) film or a transparent conductive film of a high-molecular conductive material such as polyaniline. The circuit wirings of the first substrate 10 and the transparent electrode layer 32 of the second substrate 30 are connected to each other outside the formation area of the electrophoresis layer 20. Specifically, the transparent electrode layer 32 and the connection electrodes 14 of the thin-film transistor semiconductor circuit layer 12 are connected to each other through a conductive connection 23.

A method of driving the electrophoresis display device 1 will be described now.

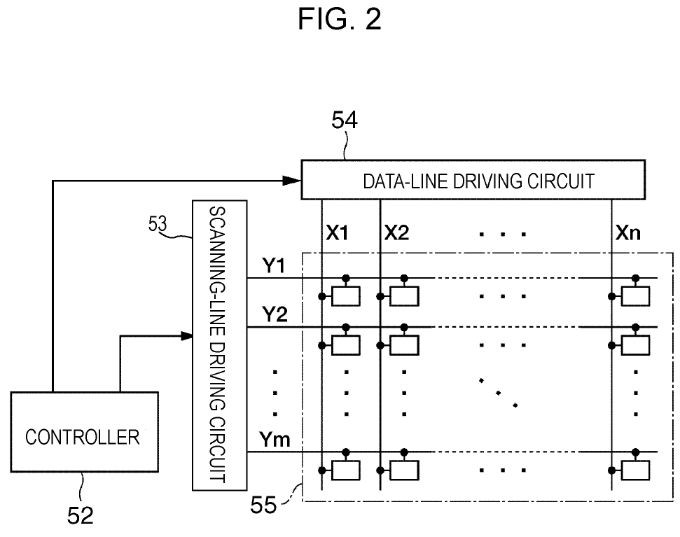

FIG. 2 is a diagram schematically illustrating the circuit structure of the electrophoresis display device 1.

A controller (voltage control unit) 52 generates image signals indicating an image to be displayed in the image display area 55, reset data for rewriting an image, and other signals (clock signals, etc.) and outputs the generated signals to a scanning-line driving circuit 53 or a data-line driving circuit 54.

The display area 55 includes a plurality of data lines arranged in parallel in an X direction, a plurality of scanning lines arranged in parallel in a Y direction, and pixel driving circuits arranged at intersections between the data lines and the scanning lines.

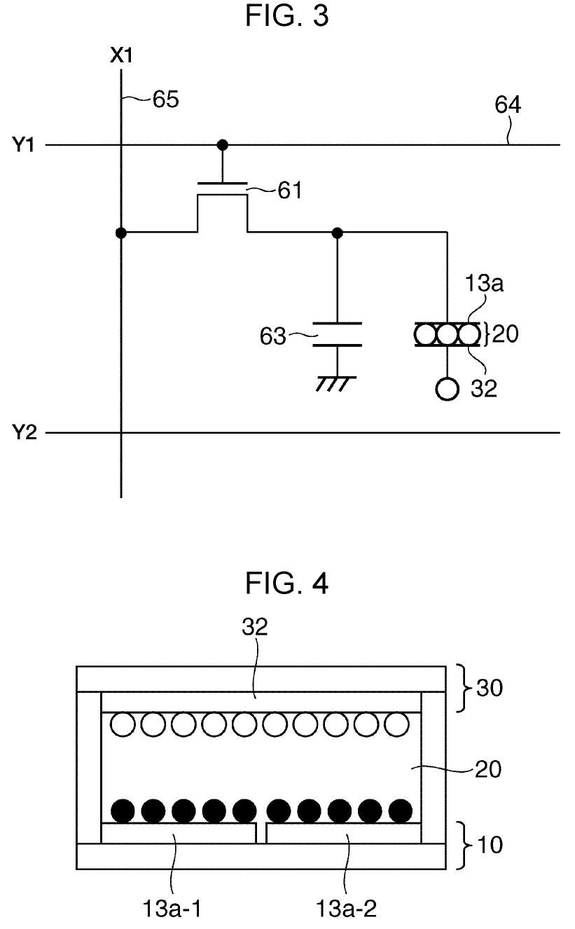

FIG. 3 is a diagram illustrating the structure of each pixel driving circuit. In each pixel driving circuit, the gate of a transistor 61 is connected to the corresponding scanning line 64, the source thereof is connected to the corresponding data line 65, and the drain thereof is connected to the corresponding pixel electrode 13a. A retention capacitor 63 is connected in parallel to the corresponding electrophoresis element. The data line 65 allows the electrophoresis particles of the electrophoresis layer 20 to migrate so as to display an image by supplying a voltage across the pixel electrode 13a of each pixel driving circuit and the transparent electrode layer 32.

The scanning-line driving circuit 53 is connected to the scanning lines of the display area 55 and serves to select one of the scanning lines and to supply predetermined scanning line signals Y1, Y2, . . . , Ym to the selected scanning line. The scanning line signals Y1, Y2, . . . , Ym are signals for sequentially shifting their active period (H level period) and are output to the scanning lines so as to sequentially turn on the pixel driving circuits connected to the scanning lines.

The data-line driving circuit 54 is connected to the data lines of the display area 55 and serves to supply data signals X1, X2, . . . , Xn to the pixel driving circuits selected by the scanning-line driving circuit 53.

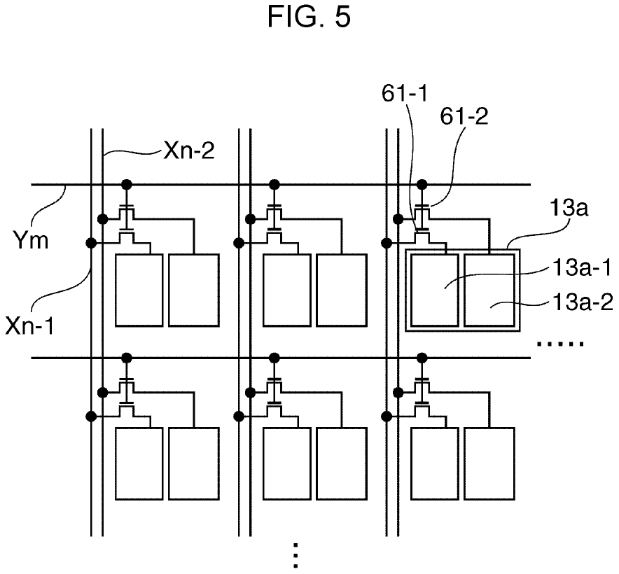

FIG. 4 is an enlarged diagram illustrating a part of FIG. 1. FIG. 5 is an enlarged diagram illustrating a part of FIG. 2.

As shown in FIGS. 4 and 5, in the electrophoresis display device 1 according to the first embodiment of the invention, each pixel electrode 13a constituting a pixel includes a sub-pixel electrode (first partial electrode) 13a-1 and a sub-pixel electrode (second partial electrode) 13a-2. As shown in FIG. 5, a transistor 61-1 and a transistor 61-2 as switching elements are connected to the sub-pixel electrodes 13a-1 and 13a-2, respectively. The gates of the transistors 61-1 and 61-2 are connected to the corresponding scanning line Ym and the sources thereof are connected to signal lines Xn-1 and Xn-2, respectively. With this configuration, by supplying a selection signal to a desired scanning line with the signal line supplied with a proper voltage, a voltage can be individually applied to the sub-pixel electrodes through the selected switching element.

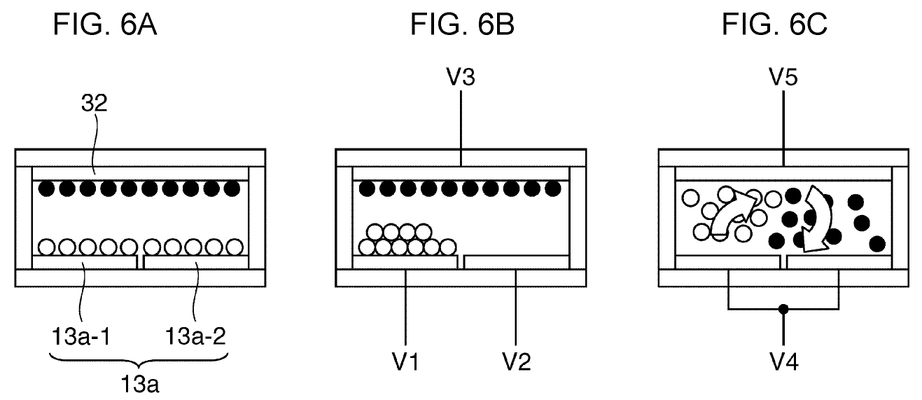

FIGS. 6A to 6C are diagrams illustrating a method of driving the electrophoresis display device 1 according to the first embodiment of the invention.

First, in the state shown in FIG. 6A, black particles are distributed close to the transparent electrode layer 32 as an observation surface and black display is observed by an observer. A case where this state is changed to white display will be described as an example.

First, as shown in FIG. 6B, the controller 52 applies potentials V1, V2, and V3 to the sub-pixel electrode 13a-1, the sub-pixel electrode 13a-2, and the transparent electrode layer 32, respectively. Here, the potentials satisfy the following relation:

V1<V2≦V3 (1)

In this state, the positively charged white particles migrate to the sub-pixel electrode 13a-1 having the lowest potential. On the other hand, the negatively charged black particles stay on the transparent electrode layer 32 having the highest potential.

Next, as shown in FIG. 6C, the controller 52 applies a potential V4 to the sub-pixel electrode 13a-1 and the sub-pixel electrode 13a-2 and applies a potential V5 to the transparent electrode layer 32. Here, the potentials V4 and V5 satisfy the following relation:

V4>V5 (2)

In this state, the white particles migrate to the transparent electrode layer 32 having the lower potential and the black particles migrate to the pixel electrode 13a (sub-pixel electrode 13a-1 and sub-pixel electrode 13a-2) having the higher potential.

At this time, since the white particles have been unevenly distributed on the sub-pixel electrode 13a-1 in advance, the white particles migrate to the transparent electrode layer 32 in the clockwise direction as shown in the figure. The black particles migrate to the pixel electrode 13a in the clockwise direction under the influence of a flow resulting from the migration of the white particles.

In this way, by unevenly distributing the white particles prior to changing the display, a flow in a predetermined direction occurs in the liquid of the electrophoresis layer 20 and the particles migrate along the flow. Accordingly, the number of collisions between the particles or the occurrence of a turbulent flow can be reduced, thereby enhancing the display change response.

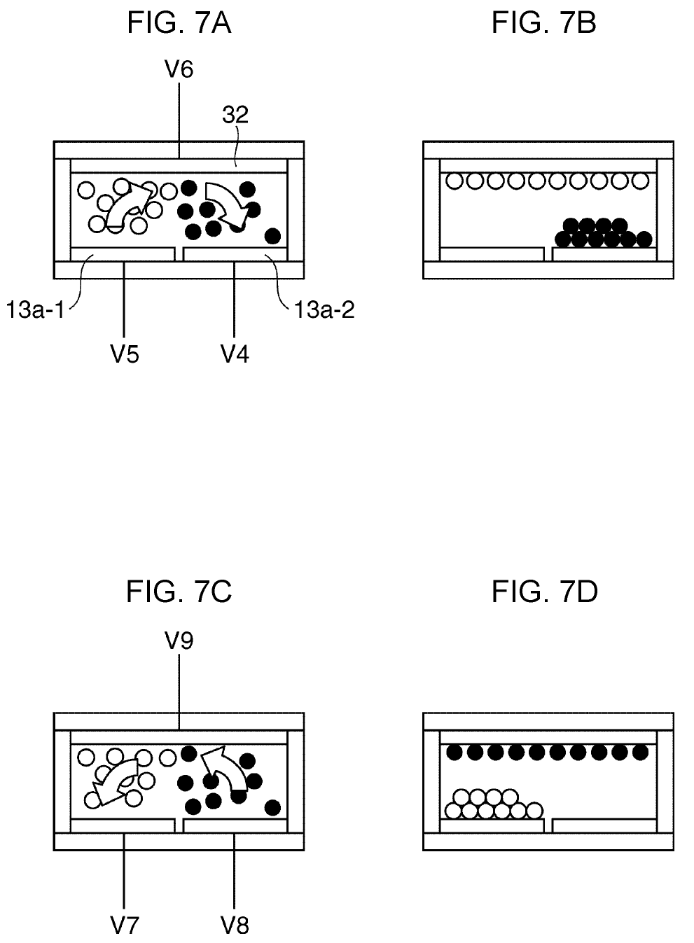

When the display is changed, like the state shown in FIG. 7A instead of the state shown in FIG. 6C, different potentials V5 and V4 may be applied to the sub-pixel electrode 13a-1 and the sub-pixel electrode 13a-2, respectively. In this case, the potentials V4 and V5 and the potential V6 applied to the transparent electrode layer 32 satisfy the following relation:

V4>V5>V6 (3)

In this state, the white particles migrate upward from the sub-pixel electrode 13a-1 to the transparent electrode layer 32 having the lowest potential. On the other hand, the black particles migrate downward from the transparent electrode layer 32 to the sub-pixel electrode 13a-2 having the highest potential. That is, a clockwise flow occurs as a whole in the state shown in FIG. 7B. In the driving method shown in FIGS. 7A to 7B, there are no black particle migrating from the transparent electrode layer 32 to the sub-pixel electrode 13a-1 in comparison with the case where the same potential is simultaneously applied to the sub-pixel electrode 13a-1 and the sub-pixel electrode 13a-2 as shown in FIG. 6. Accordingly, it is easy to form a flow in one direction. As a result, it is possible to further reduce the number of collisions between particles or the occurrence of a turbulent flow, thereby enhancing the display change response.

Subsequent to the state shown in FIG. 7B, the black particles may be evenly distributed on the pixel electrode 13a by applying an appropriate DC or AC voltage to the sub-pixel electrode 13a-1 and the sub-pixel electrode 13a-2. Alternatively, the black particles may be left in the state where the black particles are unevenly distributed on the sub-pixel electrode 13a-2. When the black particles are left in the unevenly distributed state, the process of unevenly distributing the particles on one sub-pixel electrode as shown in FIG. 6A can be omitted when the display is next changed.

When the black particles are left in the state where the black particles are unevenly distributed on the sub-pixel electrode 13a-2 as shown in FIG. 7B, voltages V7, V8, and V9 are applied to the sub-pixel electrode 13a-1, the sub-pixel electrode 13a-2, and the transparent electrode layer 32, respectively, when the display is next changed, as shown in FIG. 7C. The voltages V7, V8, and V9 satisfy the following relation:

V7<V8<V9 (4)

In this state, the white particles migrate downward from the transparent electrode layer 32 in the figure to the sub-pixel electrode 13a-1 having the lowest potential and the black particles migrate upward from the sub-pixel electrode 13a-2 to the transparent electrode layer 32 having the highest potential, thereby obtaining the state shown in FIG. 7D. In this case, since the particles migrate counterclockwise, it is possible to reduce the number of collisions between particles or the occurrence of a turbulent flow.

In this manner, since the step of unevenly distributing the particles on the sub-pixel electrode is not required prior to changing the display, it is possible to reduce the power consumption.

In the driving method shown in FIGS. 6A to 6C and FIGS. 7A to 7D, the lowest potential may be 0 V and the highest potential may be 10 V.

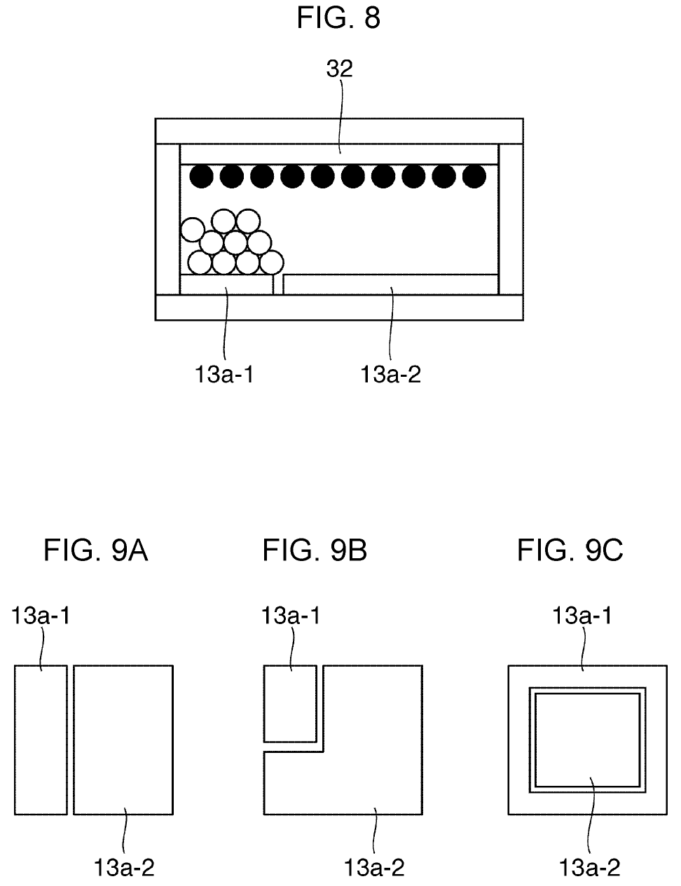

FIG. 8 is a cross-sectional view illustrating another example of the electrophoresis display device 1 according to the first embodiment of the invention. As shown in the figure, the areas of the sub-pixel electrodes may be different from each other. By controlling the particles to be unevenly distributed on the sub-pixel electrode 13a-1 having the smaller area prior to changing the display, the degree of uneven distribution of the particles increases and thus the directivity of the flow of particles becomes more remarkable. Accordingly, it is possible to further reduce the number of collisions between particles or the occurrence of a turbulent flow.

The shapes of the sub-pixel electrodes may be set similar to those shown in FIGS. 9A to 9D.

### Second Embodiment

Although the pixel electrode 13a constituting a pixel is divided into two sub-pixel electrodes in the first embodiment, the pixel electrode 13a constituting a pixel may be divided into three or more sub-pixel electrodes. In this case, a transistor as a switching element is connected to each sub-pixel electrode. The gates of the transistors are connected to the corresponding scanning line Ym and the sources thereof are connected to the signal lines Xn-1, Xn-2, and Xn-3, respectively. With this configuration, by supplying a selection signal to a desired scanning line in the state where a proper voltage to the signal line, voltages can be individually applied to the sub-pixel electrodes through the selected switching element.

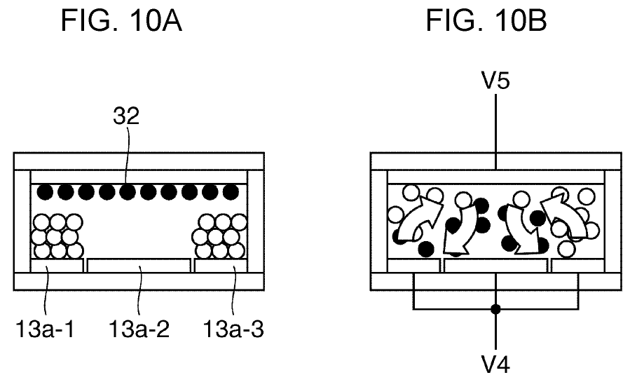

FIGS. 10A and 10B are diagrams illustrating a method of driving an electrophoresis display device 1 according to a second embodiment of the invention.

As shown in the figure, a pixel electrodes is divided into three sub-pixel electrodes 13a-1, 13a-2, and 13a-3 in the second embodiment.

In the second embodiment, as shown in FIG. 10A, a potential V1 is applied to the sub-pixel electrode 13a-1 and the sub-pixel electrode 13a-3, a voltage V2 is applied to the sub-pixel electrode 13a-2, and a potential V3 is applied to the transparent electrode layer 32, prior to changing the display. The potentials satisfy relation (1).

In this state, the positively charged white particles migrate to the sub-pixel electrode 13a-1 and the sub-pixel electrode 13a-3 having the lowest potential. On the other hand, the negatively charged black particles stay on the transparent electrode layer 32 having the highest potential.

Next, as shown in FIG. 10B, the controller 52 applies a potential V4 to the sub-pixel electrode 13a-1, the sub-pixel electrode 13a-2, and the sub-pixel electrode 13a-3 and applies a potential V5 to the transparent electrode 32. The potentials V4 and V5 satisfy relation (2).

In this state, the white particles migrate to the transparent electrode layer 32 having the lower potential and the black particles migrate to the pixel electrode 13a (sub-pixel electrode 13a-1, sub-pixel electrode 13a-2, and sub-pixel electrode 13a-3) having the higher potential.

At this time, since the white particles are unevenly distributed on the sub-pixel electrode 13a-1 and the sub-pixel electrode 13a-3 in advance, a flow in the clockwise direction is generated in the left half in the figure and a flow in the counterclockwise direction is generated in the right half. Similarly to the first embodiment, the black particles migrate to the pixel electrode 13a in the clockwise direction in the left half of the figure and migrate to the pixel electrode in the counterclockwise direction in the right half, with the influence of the flow resulting from the migration of the white particles.

In the second embodiment, by unevenly distributing the white particles prior to changing the display, a flow in a constant direction is generated in the electrophoresis layer 20 and the particles moves along the flow. Accordingly, it is possible to reduce the number of collisions between particles or the occurrence of a turbulent flow, thereby enhancing the display change response.

When the display is changed, instead of the state shown in FIG. 10B, a potential V5 may be applied to the sub-pixel electrode 13a-1 and the sub-pixel electrode 13a-3, a potential V4 may be applied to the sub-pixel electrode 13a-2, and a potential V6 may be applied to the transparent electrode layer 32. The potentials V4, V5, and V6 satisfy relation (3).

In this state, in comparison with the case where the same potential is applied to the sub-pixel electrodes 13a-1 to 13a-3 as shown in FIG. 10B, the black particles migrating from the transparent electrode layer 32 to the sub-pixel electrode 13a-1 or the sub-pixel electrode 13a-3 do not exist and thus it is more easy to form a flow in one direction. Accordingly, it is possible to further reduce the number of collisions between particles or the occurrence of a turbulent flow, thereby enhancing the display change response.

By applying a proper DC or AC voltage to the sub-pixel electrodes 13a-1 to 13a-3 after changing the display, the black particles may be evenly distributed on the pixel electrode 13a. Alternatively, the black particles may be left in the state where the black particles are unevenly distributed on the sub-pixel electrode 13a-2. When the black particles are left in the unevenly distributed state, the step of unevenly distributing particles on a specific sub-pixel electrode can be omitted when the display is next changed.

### Third Embodiment

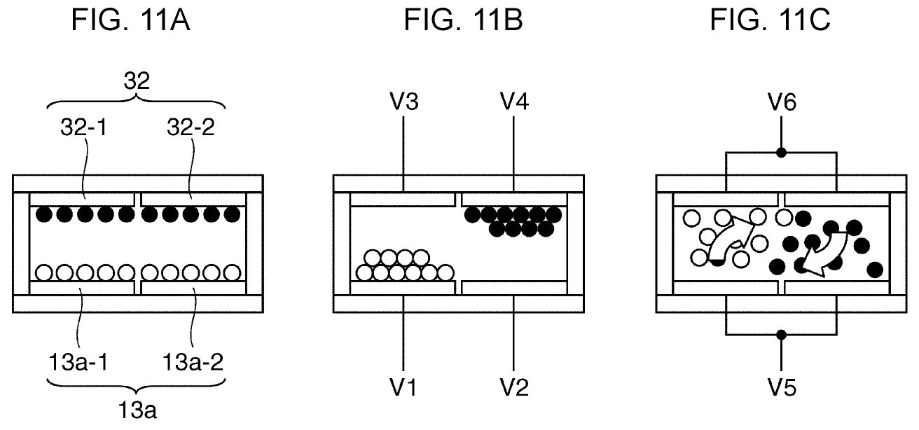

FIGS. 11A to 11C are diagrams illustrating a method of driving an electrophoresis display device 1 according to a third embodiment of the invention.

As shown in the figures, in the third embodiment, a pixel electrode 13a is divided into a sub-pixel electrode 13a-1 and a sub-pixel electrode 13a-2 and a transparent electrode layer 32 is divided into a sub transparent electrode (third partial electrode) and a sub transparent electrode (fourth partial electrode) 32-2. Different voltages can be applied to the sub transparent electrode 32-1 and the sub transparent electrode 32-2, respectively.

First, in the state shown in FIG. 11A, the black particles are distributed close to the transparent electrode layer 32 as the observation surface and the black display is observed by an observer. A case where this state is changed to the white display will be described as an example.

First, as shown in FIG. 11B, the controller 52 applies potentials V1, V2, V3, and V4 to the sub-pixel electrode 13a-1, the sub-pixel electrode 13a-2, the sub transparent electrode 32-1, and the sub transparent electrode 32-2. Here, the potentials satisfy the following relation:

V1<V2≦V3<V4 (5)

In this state, the positively charged white particles migrate to the sub-pixel electrode 13a-1 having the lowest potential. On the other hand, the negatively charged black particles migrate to the sub transparent electrode 32-2 having the highest potential.

Next, as shown in FIG. 11C, the controller 52 applies a potential V5 to the sub-pixel electrode 13a-1 and the sub-pixel electrode 13a-2 and applies a potential V6 to the sub transparent electrode 32-1 and the sub transparent electrode 32-2. Here, the potentials V5 and V6 satisfy the following relation:

V5>V6 (6)

In this state, the white particles migrate to the transparent electrode layer 32 and the black particles migrate to the pixel electrode 13a.

At this time, since the white particles are unevenly distributed on the sub-pixel electrode 13a-1 in advance and the black particles are unevenly distributed on the sub transparent electrode 32-2, the particles migrate in the clockwise direction as shown in the figure.

In the third embodiment, since the white particles and the black particles can be unevenly distributed prior to changing the display, it is easy to form a flow in one direction in the liquid of the electrophoresis layer 20. Accordingly, it is possible to almost completely prevent the collision between particles or the occurrence of a turbulent flow, thereby enhancing the display change response.

In the state shown in FIG. 11C, potentials V5, V6, V7, and V8 may be applied to the sub-pixel electrode 13a-1, the sub-pixel electrode 13a-2, the sub transparent electrode 32-1, and the sub transparent electrode 32-2. The potentials V5, V6, V7, and V8 satisfy the following relation:

V5>V6>V7>V8 (7)

In this state, in comparison with the case shown in FIG. 11C, the black particles migrating from the sub transparent electrode 32-2 to the sub-pixel electrode 13a-2 and the white particles migrating from the sub-pixel electrode 13a-1 to the sub transparent electrode 32-1 do not exist and thus it is easier to form the flow in one direction. Accordingly, it is possible to further reduce the number of collisions between particles or the occurrence of a turbulent flow, thereby enhancing the display change response.

By applying a proper DC or AC voltage to the sub-pixel electrodes 13a-1 and 13a-2 and the sub transparent electrodes 32-1 and 32-2 after changing the display, the black particles and the white particles may be evenly distributed on the pixel electrode 13a and the transparent electrode 32, respectively. Alternatively, the black particles and the white particles may be left in the state where the they are unevenly distributed on the sub-pixel electrode 13a-1 and the sub transparent electrode 32-2. When the black particles are left in the unevenly distributed state, the uneven distributing of particles can be omitted when the display is next changed.

### Electronic Apparatus

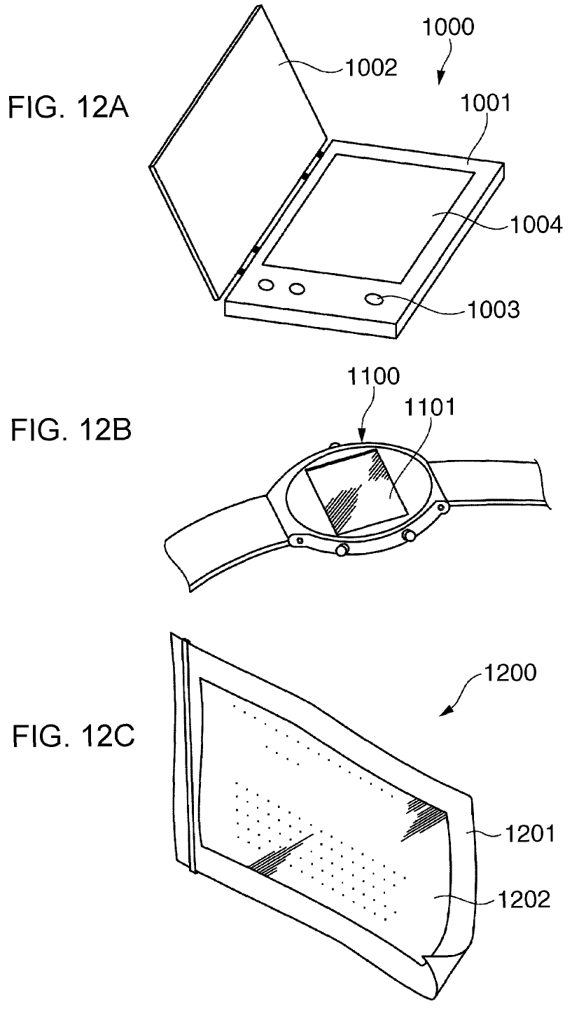

FIGS. 12A to 12C are perspective diagrams illustrating specific examples of an electronic apparatus employing the electrophoresis device according to the embodiments of the invention. FIG. 12A is a perspective view illustrating an electronic book as an example of the electronic apparatus. The electronic book 1000 includes a book-shaped frame 1001, a cover 1002 disposed so as to pivot about (open and shut) the frame 1001, a manipulation unit 1003, and a display unit 1004 employing the electrophoresis device according to the embodiments of the invention.

FIG. 12B is a perspective view illustrating a wrist watch as an example of the electronic apparatus. The wrist watch 1100 includes a display unit 1101 employing the electrophoresis device according to the embodiments of the invention.

FIG. 12C is a perspective view illustrating an electronic paper as an example of the electronic apparatus. The electronic paper 1200 includes a main body 1201 formed of a rewritable sheet having texture and flexibility like paper and a display unit 1202 employing the electrophoresis device according to the embodiments of the invention. The electronic apparatus employing the electrophoresis device is not limited to the above-mentioned examples, but may widely include apparatuses using visual change in tone accompanied with migration of charged particles. In addition to the above-mentioned apparatuses, examples of the electronic apparatus can include things belonging to real estates such as walls mounted with an electrophoresis film and things belonging to mobile objects such as vehicles, air planes, and ships.

What is claimed is:

1. An electrophoresis device comprising:
a display area including electrophoresis elements, each of which has a dispersion system, which includes first electrophoresis particles and second electrophoresis particles having different electrical polarities, between a first electrode and a second electrode disposed opposite to each other; and
a voltage control unit allowing the first and second electrophoresis particles to migrate to the first and second electrodes, respectively, so as to form an image by applying a voltage to the electrophoresis elements,
wherein the first electrode has a first partial electrode and a second partial electrode and the voltage control unit unevenly distributes the electrophoresis particles distributed close to the first electrode onto one of the first and second partial electrodes by applying different voltages to the first partial electrode and the second partial electrode prior to changing display.

2. The electrophoresis device according to claim 1, wherein the voltage control unit unevenly distributes the electrophoresis particles migrating to the first electrode onto one of the first and second partial electrodes by applying different voltages to the first partial electrode and the second partial electrode when the display is changed.

3. The electrophoresis device according to claim 1, wherein the first electrode is an electrode on a surface opposite an observation surface.

4. The electrophoresis device according to claim 1, wherein the area of the first partial electrode is different from the area of the second partial electrode.

5. The electrophoresis device according to claim 1, wherein the second electrode has a third partial electrode and a fourth partial electrode and the voltage control unit unevenly distributes the electrophoresis particles distributed close to the second electrode onto one of the third and fourth partial electrodes by applying different voltages to the third partial electrode and the fourth partial electrode prior to changing the display.

6. The electrophoresis device according to claim 5, wherein the voltage control unit unevenly distributes the electrophoresis particles migrating to the second electrode onto one of the third and fourth partial electrodes by applying different voltages to the third partial electrode and the fourth partial electrode when the display is changed.

7. The electrophoresis device according to claim 5, wherein the area of the third partial electrode is different from the area of the fourth partial electrode.

8. An electronic apparatus comprising the electrophoresis device according to claim 1.

9. A method of driving an electrophoresis device which has a display area including electrophoresis elements, each of which has a dispersion system, which includes at least two types of electrophoresis particles having different electrical polarities, between a first electrode and a second electrode disposed opposite each other and which allows first and second electrophoresis particles to migrate to the first and second electrodes, respectively, so as to form an image by applying a voltage to the electrophoresis elements,
wherein the first electrode has a first partial electrode and a second partial electrode, and
wherein the method comprises: a first process of unevenly distributing the electrophoresis particles distributed close to the first electrode onto one of the first and second partial electrodes by applying different voltages to the first partial electrode and the second partial electrode prior to changing display; and
a second process of reversing the polarities of the first electrode and the second electrode so as to allow the first and second electrophoresis particles to migrate to the opposite electrodes, thereby changing the display.

10. The method according to claim 9, wherein in the second process, the electrophoresis particles migrating to the first electrode are unevenly distributed onto one of the first and second partial electrodes by applying different voltages to the first partial electrode and the second partial electrode.

11. A method of driving an electrophoresis device which has a display area including electrophoresis elements, each of which has a dispersion system, which includes at least two types of electrophoresis particles having different electrical polarities, between a first electrode and a second electrode disposed opposite each other and which allows first and second electrophoresis particles to migrate to the first and second electrodes, respectively, so as to form an image by applying a voltage to the electrophoresis elements,
wherein the first electrode has a first partial electrode and a second partial electrode,
wherein the second electrode has a third partial electrode and a fourth partial electrode, and
wherein the method comprises: a first process of unevenly distributing the electrophoresis particles distributed close to the first electrode onto one of the first and second partial electrodes by applying different voltages to the first partial electrode and the second partial electrode prior to changing display, and unevenly distributing the electrophoresis particles distributed close to the second electrode onto one of the third and fourth partial electrodes by applying different voltages to the third partial electrode and the fourth partial electrode, prior to changing display; and
a second process of reversing the polarities of the first electrode and the second electrode so as to allow the first and second electrophoresis particles to migrate to the opposite electrodes, thereby changing the display.

12. The method according to claim 9, wherein in the second process, the electrophoresis particles migrating to the first electrode are unevenly distributed onto one of the first and second partial electrodes by applying different voltages to the first partial electrode and the second partial electrode and the electrophoresis particles migrating to the second electrode are unevenly distributed onto one of the third and fourth partial electrodes by applying different voltages to the third partial electrode and the fourth partial electrode.
